(19) United States
(12) Patent Application Publication
(10) Pub. No.: US 2009/0301099 A1
(43) Pub. Date: Dec. 10, 2009

(54) Power Generation

(76) Inventor: Nello Nigro, Victoria (AU)

Correspondence Address: BRINKS HOFER GILSON & LIONE, P.O. BOX 10395, CHICAGO, IL, 60610, US

(21) Appl. No.: 12/306,076

(22) PCT Filed: Jun. 22, 2007
(86) PCT No.: PCT/AU07/00875

§ 371 Date: Mar. 30, 2009

(30) Foreign Application Priority Data
Jun. 23, 2006 (AU) 2006903403

(51) Int. Cl. F02C 3/30; F02C 7/00; F02C 7/08

(52) U.S. Cl. 60/775; 60/783; 60/39.52

(57) ABSTRACT

A method and an apparatus for generating power via a gas turbine are disclosed. Coal bed methane and/or natural gas, air or oxygen-enriched air, and steam are supplied to a combustor of the gas turbine. Coal bed methane and/or natural gas is combusted and resultant combustion products and a flue gas drive the gas turbine and generate electricity. A hot flue gas stream from the gas turbine is supplied to a heat recovery steam generator (“HRSG”) and the generator produces high pressure steam and low pressure steam. High pressure steam is supplied to the combustor of the gas turbine. CO₂ is recovered from a flue gas from the HRSG. The recovered CO₂ is supplied to a suitable storage region, such as the coal bed seam that produced the coal bed methane used in the gas turbine.

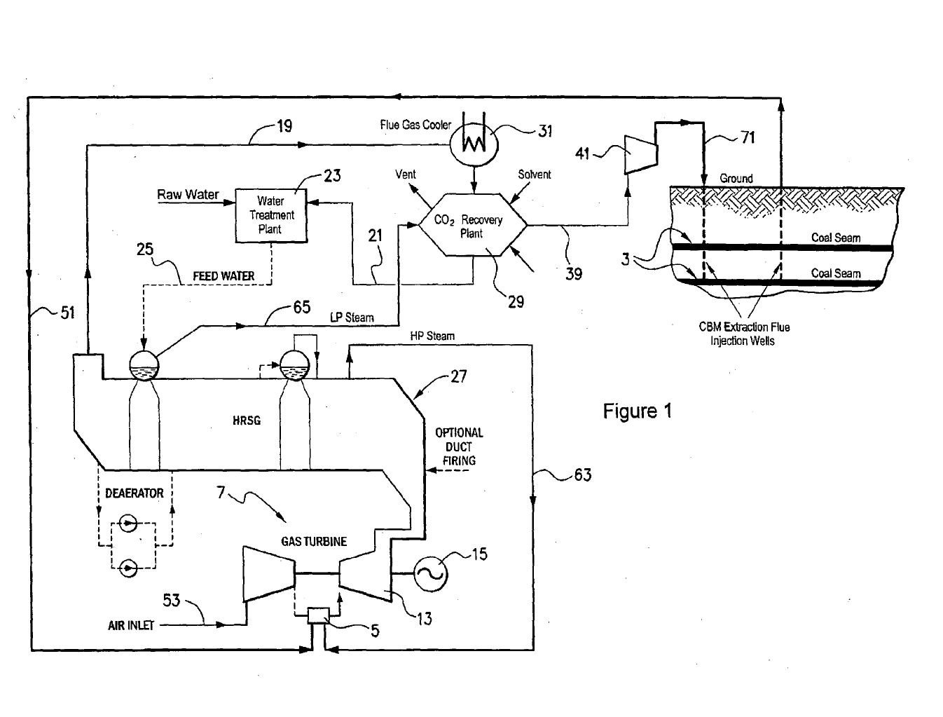

The present invention relates to a method and an apparatus for generating electrical power that is based on the use of coal bed methane gas and/or natural gas as a source of energy for driving a gas turbine for generating power.

The term “coal bed methane” is understood herein to mean gas that contains at least 75% methane gas on a volume basis obtained from an underground coal source.

The term “natural gas” is understood herein to mean hydrocarbon gases found, for example, in porous geological formations.

International application PCT/AU2004/001339 (WO 2005/5031136) in the name of the applicant describes and claims a method of generating power via a gas turbine and a steam turbine which comprises operating in a first mode by:
(a) supplying coal bed methane, an oxygen-containing gas, and flue gas produced in the gas turbine, all under pressure, to a combustor of the gas turbine and combusting the coal bed methane and using the heated combustion products and the flue gas to drive the gas turbine;
(b) supplying hot flue gas produced in the gas turbine to a heat recovery steam generator and using the heat of the flue gas to generate steam by way of heat exchange with water supplied to the steam generator;
(c) supplying steam from the steam generator to a steam turbine and using the steam to drive the steam turbine; and
(d) supplying (i) a part of the flue gas from the gas turbine that passes through the heat recovery steam generator to the combustor of the gas turbine and (ii) another part of the flue gas from the gas turbine that passes through the heat recovery steam generator to a suitable underground storage region.

The International application also discloses operating in a second mode by:
(a) supplying coal bed methane and air from an air compressor of the gas turbine, both under pressure, to the combustor of the gas turbine and combusting the coal bed methane and using the heated combustion products and the flue gas to drive the gas turbine;
(b) supplying a hot flue gas stream produced in the gas turbine to the heat recovery steam generator and using the heat of the flue gas to generate steam by way of heat exchange with water supplied to the steam generator; and
(c) supplying steam from the steam generator to the steam turbine and using the steam to drive the steam turbine.

The International application also discloses an apparatus for generating power.

The disclosure in the International application is incorporated herein by cross reference.

One of the features of the method described and claimed in the International application is that it can operate with no CO₂ emissions into the atmosphere. By way of example, by operating the first operating mode of the method so that step (d)(i) supplies all of the flue gas (which inevitably contains substantial amounts of CO₂) that is not supplied to the combustor of the gas turbine to the suitable underground storage is an effective option for preventing CO₂ emissions into the atmosphere that does not have any adverse environmental consequences.

Another feature of the method described and claimed in the International application is that the use of part of the flue gas from the gas turbine in the combustor of the gas turbine in step (d)(i) of the first operating mode of the method makes it possible to reduce, and preferably replace altogether, the use of air in the combustor of the gas turbine. The total replacement of air with oxygen and flue gas, which is predominantly CO₂ in this mode of operation, overcomes significant issues in relation to the use of air. For example, the use of air means that flue gas from the gas turbine contains a significant amount (typically at least 70 vol. %) nitrogen, an amount (typically 10 vol. %) oxygen, and an amount (typically 5-10 vol. %) CO₂. The mixture of nitrogen, oxygen, and CO₂ presents significant gas separation issues in order to process the flue gas stream properly. The replacement of air with oxygen and flue gas in this mode of operation means that the flue gas from the heat recovery steam generator is predominantly CO₂ and water and thereby greatly simplifies the processing requirements for the flue gas from the gas turbine, with the result that it is a comparatively straightforward exercise to produce a predominately CO₂ flue gas stream and supply the stream to the combustor of the gas turbine.

The applicant has now realised that a method and an apparatus of the present invention that is different to that described and claimed in the International application is a viable alternative to and has advantages over the method and the apparatus described in the International application in certain circumstances.

According to the present invention there is provided a method of generating power via a gas turbine which comprises the following steps:
(a) supplying coal bed methane and/or natural gas, air or oxygen-enriched air, and steam, all under pressure, to a combustor of the gas turbine and combusting the coal bed methane and/or natural gas and using the heated combustion products and the flue gas to drive the gas turbine for generating electricity;
(b) supplying a hot flue gas stream produced in the gas turbine to a heat recovery steam generator and using the heat of the flue gas to generate high pressure steam and low pressure steam by way of heat exchange with water supplied to the steam generator;
(c) supplying at least a part of the high pressure steam from the steam generator to the combustor of the gas turbine; and
(d) recovering CO₂ from flue gas from the gas turbine that passes through the heat recovery steam generator; and
(e) supplying recovered CO₂ to a suitable storage region.

The method of the present invention comprises the use of coal bed methane and/or natural gas.

There may be situations in which it is appropriate to use coal bed methane as the sole energy source, other situations in which it is appropriate to use natural gas as the sole energy source, and other situations in which it is appropriate to use coal bed methane and natural gas together as energy sources. The present invention extends to all of these situations.

In addition, there may be situations in which it is appropriate to use sources of energy other than coal bed methane and natural gas with coal bed methane and natural gas. The present invention extends to these situations.

The above-described method can operate with air and therefore avoids the need to provide and operate an oxygen plant.

The applicant has found that the advantage arising from the use of air described in the preceding paragraph more than off-sets the disadvantage of processing flue gas that contains significant amounts of nitrogen that is mentioned above in the context of the International application.

Preferably step (a) includes supplying air rather than oxygen-enriched air (or oxygen on its own) to the combustor of the gas turbine.

Supplying steam to the gas turbine in step (a) is advantageous because it (a) makes it possible to control the amount of nitrous oxides in flue gas produced in the gas turbine and (b) augments the power generated by the gas turbine.

Specifically, with regard to point (a) above, the steam, which typically is at a temperature of 460-480° C., reduces the flame temperature in the combustor in the gas turbine and makes it possible to keep the flame belt at temperatures, typically below 1300° C., at which nitrous oxide starts to form in the combustor.

With regard to point (b) above, steam is an expandable gas and, therefore, expands as a consequence of the increase in temperature generated in the combustor and thereby contributes to the gas flow past the gas turbine.

Preferably step (a) includes controlling the supply of air or oxygen-enriched air to the gas turbine (i) to keep the flame belt at temperatures, typically below 1300° C., at which nitrous oxide starts to form in the combustor and (ii) to augment the power produced by the gas turbine.

Preferably step (a) includes controlling the supply of coal bed methane and/or natural gas, air or oxygen-enriched air, and steam to the gas turbine so that flue gas produced in the gas turbine has less than 50 ppm nitrous oxides.

More preferably step (a) includes controlling the supply of coal bed methane and/or natural gas, air or oxygen-enriched air, and steam to the gas turbine so that flue gas produced in the gas turbine has less than 25 ppm nitrous oxides.

More preferably step (a) includes controlling the supply of steam to the gas turbine so that flue gas produced in the gas turbine has less than 50 ppm nitrous oxides.

More preferably step (a) includes controlling the supply of steam to the gas turbine so that flue gas produced in the gas turbine has less than 25 ppm nitrous oxides.

Preferably step (b) generates low pressure steam having a pressure up to 5 barg.

More preferably step (b) generates low pressure steam having a pressure up to 3.5 barg.

Preferably step (b) generates high pressure steam having a pressure of 15-60 barg.

Preferably the high pressure steam supplied to the combustor of the gas turbine in step (a) is at a pressure of 15-60 barg.

Preferably step (d) includes recovering CO₂ from flue gas from the gas turbine that passes through the heat recovery steam generator by contacting the flue gas with a solvent that absorbs CO₂ from the flue gas and produces CO₂-loaded solvent and CO₂-free flue gas.

Preferably step (d) further includes heating the CO₂-loaded solvent and stripping CO₂ from the solvent. The stripped CO₂ is thereafter supplied as recovered CO₂ to step (e) and the solvent is recycled to absorb CO₂ from flue gas.

Preferably step (d) includes heating the CO₂-loaded solvent by indirect heat exchange relationship with low pressure steam produced in the heat recovery steam generator.

Preferably the method includes using a condensate produced from low temperature steam as a consequence of heating the CO₂-loaded solvent in step (d) as feed water for generating steam for step (b).

The recovered CO₂ from step (d) may be supplied to the storage region as a gas phase or a liquid phase.

Preferably the storage region for step (e) is a coal bed seam or a geological formation that contains or contained natural gas.

More preferably the storage region is the coal bed seam and/or the natural gas geological formation from which coal bed methane and/or natural gas to power the gas turbine is extracted.

In this context, the existing well structures for extracting coal bed methane and/or natural gas can be used to transfer flue gas, in liquid or gas phases, to the underground storage region.

Preferably step (e) includes supplying the recovered CO₂ from step (d) to the storage region via existing well structures for extracting coal bed methane and/or natural gas from the storage region.

Preferably step (e) includes:
(i) compressing the recovered CO₂ from step (d) to a pressure of at least 130 barg; and thereafter
(ii) supplying the compressed CO₂ to the storage region.

According to the present invention there is also provided an apparatus for generating power which comprises:
(a) a gas turbine having an air compressor, an air expander, and a combustor;
(b) a supply system for supplying the following feed materials to the combustor of the gas turbine: coal bed methane and/or natural gas, air or oxygen-enriched air, and steam, all under pressure, for combusting the coal bed methane and/or natural gas and using the heated combustion products and the flue gas to drive the gas turbine for generating electricity;
(c) a heat recovery steam generator for generating high pressure steam and low pressure steam from water supplied to the steam generator by way of heat exchange with flue gas from the gas turbine;
(d) a supply system for supplying at least a part of the high pressure steam from the steam generator to the combustor of the gas turbine (i) for controlling the flame temperature of the combustor of the gas turbine to be sufficiently low to minimise the amount of nitrous oxides in the flue gas and (ii) for augmenting the power produced by the gas turbine;
(e) a recovery system for recovering CO₂ from flue gas from the gas turbine that passes through the heat recovery steam generator; and
(f) a supply system for supplying recovered CO₂ to a suitable storage region.

The present invention is described further with reference to the accompanying drawing which is one, although not the only, embodiment of a power generation method and apparatus of the invention.

With reference to the FIGURE, the method includes supplying the following gas streams to a combustor 5 of a gas turbine generally identified by the numeral 7:
(a) coal bed methane from an underground source 3, such as a coal seam, via (i) a separator (not shown) that separates coal bed methane and water from the gas stream from the source, (ii) a dedicated coal bed methane compressor station (not shown), and (iii) a supply line 51;
(b) air (or oxygen-enriched air), in an amount required for stoichiometric combustion of coal bed methane, via a line 53; and
(c) high pressure steam from a heat recovery steam generator 27, described hereinafter, via a line 63.

The streams of coal bed methane, air, and steam are supplied to the combustor 5 at a preselected pressure of between 15 and 60 bar. It is noted that the combustor 5 may operate at any suitable pressure.

The coal bed methane is combusted in the combustor 5 and the products of combustion are delivered to an expander 13 of the turbine 7 and drive the turbine blades (not shown) located in the expander 13.

The output of the turbine 7 is connected to and drives an electrical generator 15.

The output gas stream, i.e. the flue gas, from the turbine 7 is at atmospheric pressure and typically at a temperature of the order of 410° C.

The flue gas from the turbine 7 is passed through a heat recovery steam generator 27 and is used as a heat source for producing (a) high pressure steam, typically at a pressure of approximately 15-60 barg, and (b) low pressure steam typically at a pressure of approximately 3.5 barg, from feed water supplied to the steam generator 27. Typically, the feed water includes (a) water separated from coal bed methane extracted from the coal seam of the underground source and (b) condensate return.

The high pressure steam, typically at temperature of 460-480° C. is supplied via the line 63 to the combustor 5 of the gas turbine 7.

The low pressure steam is supplied via a line 65 to a CO₂ recovery plant, generally identified by the numeral 29, described hereinafter.

The flue gas from the heat recovery steam generator 27, which is predominantly CO₂ and water, leaves the steam generator as a wet flue gas stream, typically at a temperature of 110-140° C., and is supplied to the CO₂ recovery plant 29 via a line 19.

There are three stages in the CO₂ recovery plant 29.

In a first stage of CO₂ recovery an induction fan (not shown) draws a controlled quantity of flue gas into a flue gas cooler 31 where the flue gas is cooled to approximately 40° C.

In a second stage, cooled flue gas from the cooler 31 is supplied to an absorber tower (not specifically shown) and solvent is sprayed into the tower and contacts flue gas and absorbs CO₂ from flue gas. The resultant output of the tower is a CO₂-loaded solvent and a and CO₂-free flue gas. The CO₂-loaded solvent is treated in a third stage, described hereinafter. The CO₂-free flue gas is exhausted into the atmosphere via a vent/stack above the absorber tower.

In the third and final stage of the CO₂ recovery plant 29, the solvent in the CO₂-loaded solvent is heated by indirect heat exchange by way of low pressure steam from the heat recovery steam generator 27 in a stripper tower (not shown). The heat strips CO₂ from the solvent as a gas that is recovered. The stripped solvent is re-circulated to the absorber tower. This stripped CO₂ is greater than 99% purity.

The low pressure steam is cooled by the heat exchange with the CO₂-loaded solvent and forms a condensate and is returned via line 21, a water treatment plant 23, and line 25 as feed water to the heat recovery steam generator 27.

In addition to the condensate, the water treatment plant 23 also receives and treats water separated from coal bed methane extracted from the coal seam.

The stripped CO₂ is supplied to a compressor 41 via a line 39 and is compressed to a pressure of 75-130 barg and dried. Depending on the pressure, the CO₂ is a gas phase or a liquid phase.

The dried and compressed CO₂ is then fed into a sequestration pipeline system, including a line 71 shown in the FIGURE, and supplied therein, for example, to disused CBM production wells (converted to an injection well) that supplied coal bed methane to the method and is sequestered in the wells.

The key components of the above-described embodiment of the process and the apparatus of the invention shown in the FIGURE are as follows:
(a) Gas Turbine/Generator 7—Typically, this unit is a standard gas turbine fitted with a standard combustor. The attachment of large multi-stage compressors to gas turbine units is quite common in the steel industry where low Btu steelworks gases are compressed by these units before being delivered to the combustor for combustion.
(b) Heat Recovery Steam Generator 27—Typically, this unit is a standard double pressure unfired unit.
(c) CO₂ Recovery Plant 29—a conventional unit.
(d) CO₂ Underground Storage System—preferably the coal seam from which the coal bed methane operating the method was extracted.
(e) Water Treatment Plant—a conventional unit.

Many modifications may be made to the embodiment of the method and the apparatus of the present invention described above without departing from the spirit and scope of the invention.

By way of example, whilst the embodiment includes producing CO₂ as a gas phase or a liquid phase and then supplying the CO₂ to disused CBM production wells and sequestered, the present invention is not so limited and extends to supplying the CO₂, in gas or liquid phases, to any suitable underground location.

By way of further example, whilst the embodiment is based on the use of coal bed methane as a source of energy for driving the gas turbine 7, the present invention is not confined to such use of coal bed methane and extends to the use of natural gas in conjunction with or as an alternative to coal bed methane. In addition, the present invention extends to situations in which other energy sources are used with coal bed methane and/or natural gas.

1-18. (canceled)

19. A method of generating power via a gas turbine which comprises the following steps:
(a) supplying at least one of coal bed methane and natural gas, supplying at least one of air and oxygen-enriched air, and supplying steam, all under pressure, to a combustor of the gas turbine and combusting the at least one of the coal bed methane and natural gas and using the heated combustion products and the flue gas to drive the gas turbine for generating electricity;
(b) supplying a hot flue gas stream produced in the gas turbine to a heat recovery steam generator and using the heat of the flue gas to generate high pressure steam and low pressure steam by way of heat exchange with water supplied to the steam generator;
(c) supplying at least a part of the high pressure steam from the steam generator to the combustor of the gas turbine; and
(d) recovering CO₂ from flue gas from the gas turbine that passes through the heat recovery steam generator; and
(e) supplying recovered CO₂ to a storage region.

20. The method defined in claim 19 wherein step (a) includes supplying air to the combustor of the gas turbine.

21. The method defined in claim 19 wherein step (a) includes controlling the supply of the at least one of the air and oxygen-enriched air to the gas turbine (i) to keep a flame belt at a temperature below that which nitrous oxide starts to form in the combustor and (ii) to augment the power produced by the gas turbine.

22. The method defined in claim 19 wherein step (a) includes controlling the supply of the least one of the coal bed methane and natural gas, controlling the supply of the at least one of the air and oxygen-enriched air, and controlling the supply of the steam to the gas turbine so that flue gas produced in the gas turbine has less than 50 ppm nitrous oxides.

23. The method defined in claim 22 wherein step (a) includes controlling the supply of the at least one of coal bed methane and/or natural gas, controlling the supply of the at least one of the air and oxygen-enriched air, controlling the supply of the steam to the gas turbine so that flue gas produced in the gas turbine has less than 25 ppm nitrous oxides.

24. The method defined in claim 19 wherein step (a) includes controlling the supply of steam to the gas turbine so that flue gas produced in the gas turbine has less than 50 ppm nitrous oxides.

25. The method defined in claim 24 wherein step (a) includes controlling the supply of steam to the gas turbine so that flue gas produced in the gas turbine has less than 25 ppm nitrous oxides.

26. The method defined in claim 19 wherein step (b) generates low pressure steam having a pressure up to 5 barg.

27. The method defined in claim 19 wherein step (b) generates high pressure steam having a pressure between about 15 to about 60 barg.

28. The method defined in claim 19 wherein the high pressure steam supplied to the combustor of the gas turbine in step (a) is at a pressure between about 15 to about 60 barg.

29. The method defined in claim 19 wherein step (d) includes recovering CO₂ from flue gas from the gas turbine that passes through the heat recovery steam generator by contacting the flue gas with a solvent that absorbs CO₂ from the flue gas and produces CO₂-loaded solvent and CO₂-free flue gas.

30. The method defined in claim 29 wherein step (d) further includes heating the CO₂-loaded solvent and stripping CO₂ from the solvent.

31. The method defined in claim 30 wherein step (d) includes heating the CO₂-loaded solvent by indirect heat exchange relationship with low pressure steam produced in the heat recovery steam generator.

32. The method defined in claim 31 includes using a condensate produced from low temperature steam as a consequence of heating the CO₂-loaded solvent in step (d) as feed water for generating steam in step (b).

33. The method defined in claim 19 wherein step (e) includes supplying recovered CO₂ from step (d) to the storage region as a gas phase or a liquid phase.

34. The method defined in claim 19 wherein the storage region for step (e) is at least one of a coal bed seam and a geological formation that contains or contained natural gas.

35. The method defined in claim 19 wherein step (e) includes:
(i) compressing the recovered CO₂ from step (d) to a pressure of at least 130 barg; and thereafter
(ii) supplying the compressed CO₂ to the storage region.

36. An apparatus for generating power which comprises:
(a) a gas turbine having an air compressor, an air expander, and a combustor;
(b) a supply system for supplying the following feed materials to the combustor of the gas turbine: one of coal bed methane and natural gas, one of air and oxygen-enriched air, and steam, all under pressure, for combusting the coal bed methane and using the heated combustion products and the flue gas to drive the gas turbine for generating electricity;
(c) a heat recovery steam generator for generating high pressure steam and low pressure steam from water supplied to the steam generator by way of heat exchange with flue gas from the gas turbine;
(d) a supply system for supplying at least a part of the high pressure steam from the steam generator to the combustor of the gas turbine (i) for controlling a flame temperature of the combustor of the gas turbine to be sufficiently low to minimise the amount of nitrous oxides in the flue gas and (ii) for augmenting the power produced by the gas turbine;
(e) a recovery system for recovering CO₂ from flue gas from the gas turbine that passes through the heat recovery steam generator; and
(f) a supply system for supplying recovered CO₂ to a suitable storage region.
